(19) United States
(12) Patent Application Publication
(10) Pub. No.: US 2014/0060066 A1
(43) Pub. Date: Mar. 6, 2014

(54) METHOD FOR OPERATING A GAS TURBINE IN THE CASE OF LOAD SHEDDING, A DEVICE FOR CONTROLLING THE OPERATION OF A GAS TURBINE AND A POWER PLANT

(71) Applicant: Holger Hesse, Berlin (DE)

(72) Inventor: Holger Hesse, Berlin (DE)

(21) Appl. No.: 13/990,435

(22) PCT Filed: Oct. 31, 2011
(86) PCT No.: PCT/EP2011/069099

§ 371 Date: Jun. 25, 2013

(30) Foreign Application Priority Data
Nov. 30, 2010 (EP) 10193132.7

(51) Int. Cl. F02C 9/00

(52) U.S. Cl. CPC F02C 9/00
USPC 60/773; 60/722; 60/39.24

(57) ABSTRACT

A method is provided for operating a gas turbine in the event of load shedding and/or rapid shutdown. The method includes operating the gas turbine by the combustion of fuel in a combustion chamber of the gas turbine with the addition of combustion air via an air passage, and driving a load. Upon or directly after the load shedding or rapid shutdown, an additional gas volume is supplied to the combustion chamber via the air passage in order to slow the drop in pressure level in the combustion chamber.

### CROSS REFERENCE TO RELATED APPLICATIONS

This application is the US National Stage of International Application No. PCT/EP2011/069099, filed Oct. 31, 2011 and claims the benefit thereof. The International Application claims the benefits of European application No. 10193132.7 EP filed Nov. 30, 2010. All of the applications are incorporated by reference herein in their entirety.

### FIELD OF INVENTION

The invention relates to a method for operating a gas turbine in the event of load shedding and/or in the event of rapid shutdown, having the steps: operating the gas turbine by the combustion of fuel in at least one combustion chamber of the gas turbine with the addition of combustion air. Furthermore, the invention relates to a device for regulating the operation of a gas turbine, by means of which device a method for operating a gas turbine in the event of load shedding and/or in the event of rapid shutdown can be carried out, and to a power plant comprising a gas turbine having at least one combustion chamber and one compressor, wherein combustion air provided by the compressor, and fuel, can be supplied to the combustion chamber.

### BACKGROUND OF INVENTION

A wide variety of power plants and static gas turbines and methods for operating gas turbines are known from the prior art. The static gas turbines normally drive an electrical generator which feeds the electrical energy generated by it into an electricity distribution grid. During this time, the shaft train of the power plant, which comprises the generator rotor and the gas turbine rotor, rotates at the grid frequency of the electricity distribution grid: at a rotational speed of 3000 rpm in the case of 50 Hz grid frequency and at a rotational speed of 3600 rpm in the case of 60 Hz grid frequency. The rotational speed is imposed upon the shaft train by the grid frequency owing to the normally synchronously operating generators.

In the event of an unplanned separation of the generator from the electricity distribution grid, it is the case firstly that the load that brakes the gas turbine rotor is eliminated. Secondly, the rotational speed of the shaft train is no longer predefined by the grid frequency. Upon the onset of the above-mentioned situation, also known as load shedding or load rejection, it has hitherto been the case that the fuel valves were closed to a degree necessary for idle operation. If a multi-stage burner system is provided, all of the burner stages with the exception of that required for idle operation are deactivated, and the fuel valves thereof closed. Owing to the pressure gradient that arises in the gas turbine, the fuel fraction remaining in the fuel line between the closed fuel valves and the fuel nozzles escapes into the combustion chamber. In the combustion chamber, said fuel fraction assists the combustion that is still taking place, whereby the rotor continues to be driven in the turbine unit. As a result, the rotor of the gas turbine or of the shaft train accelerates, such that the rotational speed increases significantly and thus rises to a so-called overspeed. The rotational speed thereafter falls again and the gas turbine is operated further at idle.

A similar method is known for the situation of a rapid shutdown. A rapid shutdown is generally triggered in the event of an operational fault of the gas turbine or of the power plant. Here, too, the generator is separated from the electricity distribution grid. Furthermore, however, all of the fuel valves are closed and the combustion is stopped as quickly as possible. In this case, too, the fuel that expands out of the lines between the fuel valves and burner nozzles still effects a short rotational speed acceleration of the gas turbine. Thereafter, however, the rotor runs down and is kept in a so-called turning mode at a low rotational speed of a few hundred revolutions per minute in order to cool the gas turbine.

Both in the event of load shedding and also in the event of a rapid shutdown, it must accordingly be ensured that the rotational speed acceleration that occurs does not take place too rapidly and that a certain overspeed is not exceeded. Said operating situations can otherwise lead to extensive and permanent damage both in the gas turbine and also in the generator.

For this reason, it is always particularly important in the event of load shedding and rapid shutdown to keep the overspeed of the rotor or of the shaft train and the gradient of the rotational speed acceleration as low as possible.

To keep the line volume between the fuel valves and the fuel nozzles as small as possible, it has therefore hitherto been the case that the corresponding fuel valves were arranged as close as possible to the fuel nozzles. It was possible in this way to attain a limitation of the overspeed. The reduction of the distance is however subject to temperature-related or geometric limits. Overall, therefore, it is sought to further reduce the overspeed and the maximum acceleration of the rotor rotational speed.

To counteract this problem, U.S. Pat. No. 5,680,753 proposes that, in the event of load shedding, the fuel flow at premix burners be briefly stopped by means of a regulating valve and a bypass valve connected in parallel therewith.

At the same time, it is known that quenching of the flames in the gas turbine can occur in the event of load shedding. To prevent this, U.S. Pat. No. 5,896,736 proposes that the ratio of the fuel/air mixture be briefly varied. For this purpose, in the event of load shedding, a correction signal for the position of the compressor inlet guide blades is generated, by means of which signal said compressor inlet guide blades close further for a predetermined time period. As a result, a small amount of compressor air flows into the burner, whereby the fuel-air mixture is enriched.

In addition, WO 99/54610 A1 discloses the purging of fuel lines and burner stages of a gas turbine with air after load shedding. Accordingly, the fuel still present in the lines is fed at increased pressure into the combustion chamber. This leads to an undesired prolongation of the preceding combustion process, with a correspondingly increased overspeed.

Furthermore, it is known that gas turbines can also be fired with low-calorific fuels, for example synthesis gas. Such gas turbines have—in relation to gas turbines of identical rated power which are operated with high-calorific fuels—significantly larger line cross sections for the fuel lines in order to likewise be able to provide the corresponding amount of energy. As a result, the previous concept for limiting the overspeed of the rotor of the gas turbine or of the shaft train of the power plant is not adequate in the case of gas turbines for low-calorific fuels.

### SUMMARY OF INVENTION

It is therefore an object of the invention to provide a method for operating a gas turbine in the event of load shedding and/or a rapid shutdown, by means of which method as low as possible an overspeed and/or a low rotational speed acceleration can be realized. It is a further object of the invention to provide a device for regulating the operation of a gas turbine, by means of which device the overspeed of the gas turbine in the event of load shedding and rapid shutdown can be reduced. It is a further object of the invention to provide a power plant in which likewise the stated disadvantages can be reliably avoided.

The above objects are achieved by the features of the independent claim(s).

The invention is based on the realization that the acceleration of the rotor rotational speed and the overspeed are dependent also on the pressure level in the combustion chamber and the profile of said pressure level with respect to time.

All of the solutions provide that, upon or directly after the load shedding and/or rapid shutdown, an additional gas volume is supplied to the combustion chamber via an air passage in order to correspondingly set the pressure level in the combustion chamber, and the profile of said pressure level with respect to time, in order to achieve the desired aim. The expression “additional” relates to the fuel amount and the combustion air amount which would otherwise—without corresponding measures—be fed into the combustion chamber of the gas turbine after the load shedding or rapid shutdown.

As a result of the fastest possible introduction of an additional gas volume in relation to the fuel and in relation to the combustion air into the combustion chamber, the pressure level in said combustion chamber falls more slowly in relation to operation without the supply of an additional gas volume. This has the effect that the residual fuel situated in the fuel line between closed fuel valves and fuel nozzles must now expand counter to the increased pressure which prevails in the combustion chamber for a longer period of time, such that directly after the load shedding or rapid shutdown, firstly a smaller amount of fuel than previously can flow into the combustion chamber and be burned so as to perform. This slowed output of power after the closing of the fuel valves leads to a reduced acceleration of the rotor rotational speed. The gas turbine rotor and the generator rotor coupled thereto, as a shaft train of the power plant, then react with a lower overspeed than would have been the case without the supply of the additional gas volume. Consequently, with the specified method, the maximum overspeed in the event of load shedding or rapid shutdown is limited, which has the result that the rotating components are subject to reduced mechanical loading and also reduced centrifugal force loading. This lengthens the service life of the rotating components and protects the components against damage. It is preferable for compressed air to be used as a gas volume. It is self-evidently also conceivable for other media, for example nitrogen or the like, to be fed in after the load shedding or rapid shutdown in order to maintain a higher pressure in the combustion chamber.

It is preferable for the gas volume to be extracted from a correspondingly dimensioned gas store or gas tank. In the case of gas turbines which are designed for operation with low-calorific fuels, and which thus have a so-called air extraction line, the gas volume can be extracted from said air extraction line. Such gas turbines generally have an air extraction line if compressed air is required for the production of the low-calorific fuel. The extracted air amount constitutes a significant fraction of the total compressor mass stream. In general, the compressed air is supplied to an air separation plant. A part of the air which is separated into its constituents is then used for generating the low-calorific fuel. Since such air extraction lines are normally relatively long—generally 100 m and longer—they have a corresponding volume.

Even though, during operation, compressor air is supplied continuously to the air extraction line at the inlet side and is extracted continuously from the air extraction line at the outlet side, said air extraction line can also be regarded and used as a store for a gas volume. In this respect, there is stored in the air extraction line a relatively large air amount which, in the event of load shedding or rapid shutdown, is then not supplied to the air separation plant. Instead, the air currently present in said air extraction line is conducted, counter to its previous flow direction, back in the direction of the gas turbine compressor and then onward to the combustion chamber in order to be supplied as an additional gas volume to the combustion chamber. For this purpose, it is necessary merely for the valve provided in the air extraction line at the inlet side to remain open in the event of load shedding and rapid shutdown.

The method can preferably be implemented in power plants in which, during operation, a gas turbine drives an electrical generator which is connected to an electricity distribution grid, and in which the load shedding takes place as a result of an abrupt reduction in the electrical power to be imparted by the generator or as a result of the separation of the generator from the electricity distribution grid.

It is self-evidently possible for the method according to the invention to advantageously also be used if the load shedding or rapid shutdown takes place in unplanned fashion or is also only simulated. The latter is required for example during the commissioning of newly constructed gas turbine plants, wherein the correct mode of operation of the gas turbine must be proven to the operator.

The device according to the invention comprises an input by means of which can be supplied a signal which represents the load state of the gas turbine or a signal which represents the coupling state of the generator and electricity distribution grid. Furthermore, the device comprises an output whose signal controls an actuating element by means of which a gas volume, which in normal operation of the gas turbine is not intended for being supplied into the combustion chamber, can be supplied to a combustion chamber of the gas turbine, wherein a unit is provided which controls the output signal as a function of the input signal, preferably in accordance with the method described above.

The power plant according to the invention comprises a gas turbine having at least one combustion chamber and one compressor, wherein combustion air provided by the compressor, and fuel, can be supplied to the combustion chamber. According to the invention, the power plant furthermore has a chamber which is filled with a gas volume, and means are provided by which, in the event of load shedding and/or rapid shutdown, the gas volume can be fed into the combustion chamber in addition to the combustion air and in addition to the fuel.

The features directed to the method can likewise be transferred analogously to a power plant, wherein the method advantages then apply correspondingly.

### BRIEF DESCRIPTION OF THE DRAWINGS

Further advantages, features and characteristics of the invention will be explained in more detail below on the basis of preferred exemplary embodiments in the following drawing. Expedient refinements also emerge from advantageous combinations of features of the illustrated device according to the invention.

In the drawing:

FIG. 1 is a schematic illustration of a power plant, showing some components of a gas turbine and a generator coupled thereto;

FIG. 2 shows a time-pressure diagram of the pressure in a combustion chamber of the gas turbine;

FIG. 3 shows a time-rotational speed diagram of the gas turbine rotor; and

FIG. 4 is a schematic illustration of a refinement, alternative to FIG. 1, of the power plant according to the invention.

### DETAILED DESCRIPTION OF INVENTION

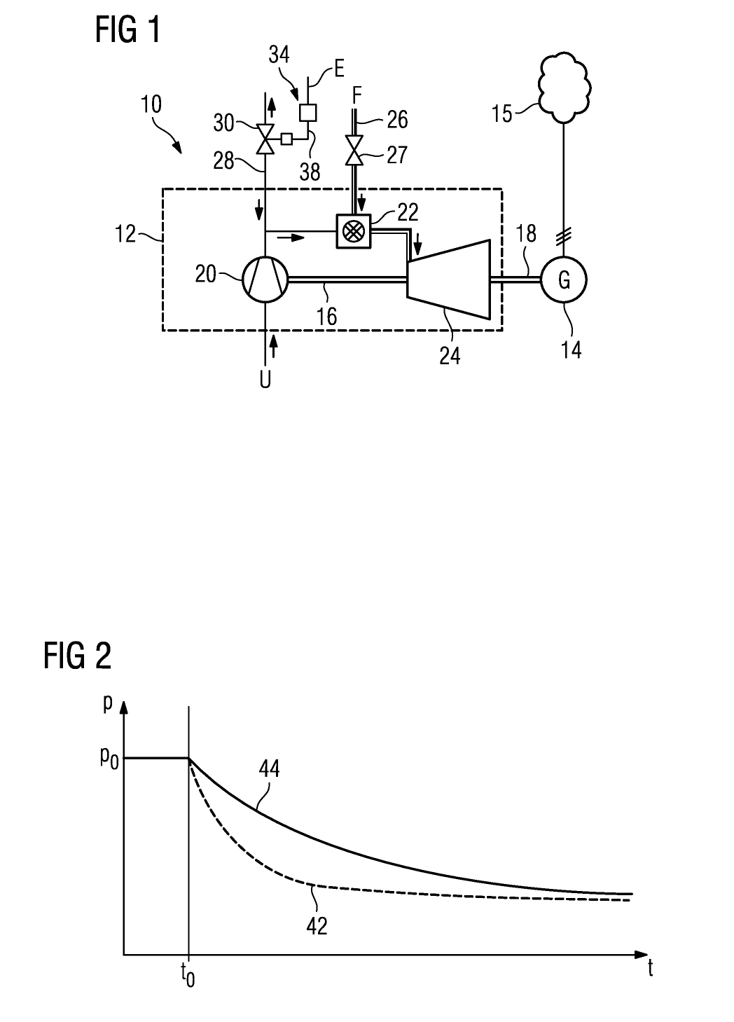

FIG. 1 is a schematic illustration of a power plant 10. The power plant 10 comprises a gas turbine 12 and a generator 14 coupled thereto. During operation, said generator feeds the electrical energy generated by it during this time into an electricity distribution grid 15. The power plant 10 may also comprise a steam turbine. The coupling of the generator 14 to the gas turbine 12 and to the steam turbine is realized in a known way by means of the connection of the gas turbine rotor 16, and if appropriate of the steam turbine rotor, to the rotor 18 of the generator 14 so as to form a shaft train. Further components of the gas turbine 12 illustrated here are the compressor 20, the combustion chamber 22 and the turbine unit 34. The combustion chamber 22 may on the one hand be designed as an annular combustion chamber. On the other hand, the combustion chamber 22 may also comprise a plurality of combustion spaces, which are known as tubular combustion chambers.

The gas turbine 12 illustrated in FIG. 1 is provided for operation with a low-calorific fuel F, for example synthesis gas or the like, which fuel can be supplied to the combustion chamber 22 via a corresponding fuel line 26 and the main burner connected thereto. In the fuel line there is arranged a fuel valve 27 which, in the event of load shedding, shuts off the supply of fuel F into the combustion chamber 22 via the main burner. If the gas turbine 12 is also equipped with pilot burners, said pilot burners continue to be supplied with a fuel in the event of load shedding.

The compressor 20 is designed and dimensioned such that, during operation, it sucks in and compresses significantly more ambient air U than the amount required for the combustion of the supplied fuel F. For this reason, the gas turbine 12 comprises, at the compressor outlet, an air extraction line 28 by means of which a relatively large amount of compressor exit air can be extracted and conducted onward for example to an air separation plant (not illustrated). Here, the extraction of compressor exit air for the air separation plant may be controlled by means of a valve 30 which, in a conventional manner, is provided in the direct vicinity of the compressor housing. In other words, the valve 30 is arranged in the air extraction line 28 at the inlet side.

During the operation of the first exemplary embodiment of the power plant 10 illustrated in FIG. 1, the air compressed by the compressor 20 is introduced into the combustion chamber 22 via air passages which are provided in the burners. The addition of combustion air into the combustion chambers 22 takes place via corresponding burner stages of the burners. The fuel-air mixture thereafter burns to form a hot gas. Said hot gas subsequently expands in the turbine unit 24 at the rotor blades of the gas turbine rotor 16 while performing work. The generator rotor 18 which is rigidly coupled to the gas turbine rotor 16 is thereby driven, whereby the generator 14, during this time, generates electrical energy and feeds said electrical energy into the electricity distribution grid 15.

FIG. 2 shows the pressure profile in the combustion chamber 22. Up to the time t0, the pressure profile is constant (normal operation), under the assumption that the gas turbine 12 must impart an arbitrary but constant load.

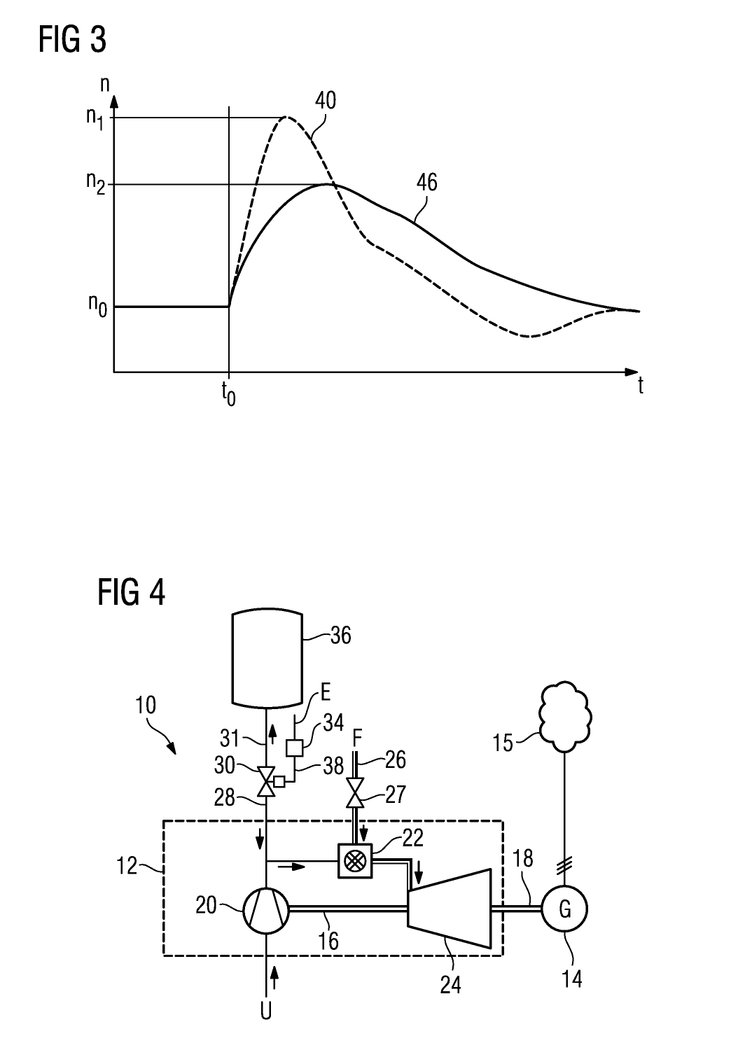

FIG. 3 shows the rotational speed of the gas turbine rotor 16 and of the generator rotor 18 rigidly coupled thereto, wherein the rotational speed n0 up to the time t0 is predefined by the grid frequency of the electricity distribution grid 15.

At the time t0, load shedding occurs, for example as a result of an unplanned separation of the generator 14 from the electricity distribution grid 15. As a result of the loss of contact between the generator 14 and the electricity distribution grid 15, the rotational speed of the rotors 16, 18 is no longer predefined by the grid frequency of the electricity distribution grid 15. Likewise, the braking action that was previously generated by the electrically requested power is eliminated.

In the case of gas turbines known from the prior art, the pressure in the combustion chamber fell relatively quickly after load shedding. The previous profile of the combustion chamber pressure p is schematically illustrated in FIG. 2 as a characteristic curve 42 with dashed lines. Said previous profile resulted in a rotational speed profile as depicted in FIG. 3 by the characteristic curve 40 illustrated with dashed lines. Accordingly, the rotational speed of the rotors increased with a high gradient—that is to say relatively quickly—up to a maximum overspeed n1, and thereafter fell with a relatively high gradient, which however had a negative sign, to the setpoint rotational speed n0 again after a short undershoot.

It is now provided according to the invention that, to limit the overspeed of a gas turbine 12 in the event of load shedding, an additional gas volume is supplied to the combustion chamber upon—that is to say at the time t0—or directly after load shedding—that is to say directly after the time t0—in order to generate a slowed pressure drop in the combustion chamber 22. In the embodiment of the power plant 10 illustrated in FIG. 1, this is achieved by virtue of the valve 30 arranged in the air extraction line 28 not being closed, as before, but rather remaining open in the event of load shedding. The pressure conditions that are then set in the gas turbine have the effect that the gas volume, that is to say compressor exit air, arranged downstream of the valve 30 in the air extraction line 28 immediately reverses its flow direction and flows without delay into the combustion chamber 22 via the air passage. The air extraction line 28 thus serves as a gas store. Owing to the provision of the additional gas volume from the air extraction line 28 and the supply of the gas volume stored therein into the combustion chamber 22, the pressure drop in the combustion chamber 22 can be slowed in relation to the prior art. This is illustrated in FIG. 2. The characteristic curve 44 shown in said figure with a solid line shows the pressure profile, with its slowed pressure decrease, in the combustion chamber 22 during the implementation of the method according to the invention.

As a result of the slowed or slower pressure drop in the combustion chamber 22, the residual fuel remaining in the fuel lines between the fuel valve 27 and the fuel nozzles escapes more slowly into the combustion chamber 22 in relation to the follow-on flow of the remaining residual fuel without the additionally fed-in gas volume. This has the result that, for the first time, less residual fuel is burned, and thus, for the first time, less thermal power is generated in the combustion chamber 22. Accordingly, the hot gas also imparts less energy to the gas turbine rotor 16 in the turbine unit 24. As a result of the slowing of the power output with respect to time directly after the load shedding, the maximum overspeed n2 of the gas turbine rotor 16 can be reduced. This is visualized in FIG. 3, in which the characteristic curve denoted by 46 represents the profile of the rotor rotational speed that arises after the load shedding at the time t0 if an additional gas volume is supplied to the combustion chamber 22. Even though the drop to the nominal rotational speed n0 after the maximum overspeed is reached takes place with a shallower gradient and with a higher rotational speed than previously, this exerts less load on the components than the overspeed n1 that has otherwise occurred previously.

In an alternative embodiment of the invention which is schematically illustrated in FIG. 4, it is possible instead of the air extraction line 28 for a gas tank 36 to be used as a gas store, which gas tank can be filled for example with compressed air extracted from the compressor 20. The features otherwise known from FIG. 1 are denoted in FIG. 4 by identical reference signs.

It is self-evidently not of importance for the invention whether the combustion chamber 22 illustrated schematically in FIGS. 1 and 4 is provided as an annular combustion chamber or as a so-called tubular combustion chamber, which the gas turbine may have for example two or also significantly more of.

The solution illustrated in FIG. 4 is also suitable in particular for static gas turbines which are intended for operation with high-calorific or higher-calorific fuel, because in general, such gas turbines 12 do not exhibit a significant extraction of compressor air aside from the cooling and sealing air used in the turbine unit and in the combustion chamber. Accordingly, the compressor 20 illustrated in FIG. 4 is dimensioned suitably for the thermal power output provided in the turbine unit 24.

Both embodiments comprise in each case one device 34 for regulating the operation of the gas turbine 12. The device 34 comprises at least one input E to which a signal representing the load state of the gas turbine 12 or a signal representing the coupling state of the generator 14 and electricity distribution grid 15 can be supplied. Furthermore, the device 34 comprises an output 38 whose signal controls an actuating element, that is to say the valve 30, by means of which a gas volume not intended for being supplied into the combustion chamber 22 during the operation of the gas turbine 12 can be supplied to the combustion chamber 22 of the gas turbine 12.

The exemplary embodiments illustrated in FIGS. 1 and 4 serve merely for explaining the invention and do not restrict the latter. It is possible in particular for a plurality of combustion chambers 22 to be provided which comprise in each case one pilot burner and one main burner with in each case one or more stages. The invention has been described on the basis of an example with gaseous fuel. The use of gaseous fuel is however not imperative.

The invention has been described on the basis of the example of load shedding. That which has been described above nevertheless likewise applies to a rapid shutdown. Here, it is necessary merely to observe the difference that the rapid shutdown leads to a stoppage of the gas turbine.

Overall, the invention relates to a method for limiting an overspeed of a gas turbine 12 in the event of load shedding, having the steps: operating the gas turbine 12 by the combustion of fuel F in a combustion chamber 22 of the gas turbine 12 and the supply of combustion air. The invention also relates to a device 34 for regulating such operation and to a power plant 10 having a gas turbine 12 and a generator 14. To further reduce the maximum overspeed of the gas turbine rotor 16 in the event of load shedding, it is proposed that, upon or directly after the load shedding, an additional gas volume is supplied to the combustion chamber 22 in addition to the otherwise supplied combustion air and in addition to the otherwise supplied combustion fuel stream.

1-10. (canceled)

11. A method for operating a gas turbine in the event of load rejection and/or rapid shutdown, comprising:
operating the gas turbine by the combustion of fuel in a combustion chamber of the gas turbine with the addition of combustion air via an air passage, and
driving a load,
the method further comprising:
upon or directly after the load rejection or rapid shutdown, supplying an additional gas volume to the combustion chamber via the air passage in order to slow the drop in pressure level in the combustion chamber.

12. The method as claimed in claim 11, wherein the gas volume is extracted from a gas store.

13. The method as claimed in claim 11, wherein compressed air is used as a gas volume.

14. The method as claimed in claim 11, further comprising extracting, during the operation of the gas turbine , a fraction of the air compressed in a compressor of the gas turbine from said compressor via an air extraction line,
wherein, in the case of load rejection or rapid shutdown, the compressed air flowing in the air extraction line is used as a gas volume.

15. The method as claimed in claim 11, wherein, during operation, the gas turbine drives an electrical generator which is connected to an electricity distribution grid, and wherein the load rejection takes place as a result of an abrupt reduction in the electrical power to be imparted by the generator or as a result of the separation of the generator from the electricity distribution grid.

16. The method as claimed in claim 11, wherein the load rejection takes place in unplanned fashion or is simulated.

17. A device for regulating the operation of a gas turbine, comprising:
an input to which can be supplied a signal which represents the load state of the gas turbine or a signal which represents the coupling state of the generator and electricity distribution grid,
an output whose signal controls an actuating element via which a gas volume can be supplied via an air passage to a combustion chamber of the gas turbine, and
a unit which controls the output signal as a function of the input signal, for carrying out the method as claimed in claim 11.

18. A power plant, comprising:
a gas turbine having at least one combustion chamber and one compressor, wherein combustion air provided by the compressor is supplied to the combustion chamber via an air passage, and fuel is supplied to the combustion chamber,
wherein
a chamber is provided which is filled with a gas volume and which is situated outside the gas turbine, and means are provided by which the gas volume can be fed via the air passage into the combustion chamber in addition to the combustion air and in addition to the fuel.

19. The power plant as claimed in claim 18, wherein the chamber is arranged in a gas tank and the means comprises a line which connects the gas tank to the combustion chamber, in which line is arranged an actuating element for opening and closing the line.

20. The power plant as claimed in claim 18, comprising a device as claimed in claim 17.
